(19) United States
(12) Patent Application Publication
(10) Pub. No.: US 2015/0293563 A1
(43) Pub. Date: Oct. 15, 2015

(54) MOBILE-COMPUTER SUPPORT APPARATUS

(71) Applicant: ThinPAD Technology (Shenzhen) Co., Ltd., Shenzhen (CN)

(72) Inventors: Jonathan WHARRAD, Evesham (GB); Colin BEATTIE, Evesham (GB)

(21) Appl. No.: 14/669,940

(22) Filed: Mar. 26, 2015

Related U.S. Application Data
(63) Continuation of application No. PCT/GB2013/052520, filed on Sep. 26, 2013.

(30) Foreign Application Priority Data
Sep. 26, 2012 (GB) 1217194.8

(51) Int. Cl. G06F 1/16; H02J 7/00; G06F 21/86; G06F 21/88; G06F 13/40; H04L 9/32

(52) U.S. Cl. CPC G06F 1/1632; G06F 13/4081; H04L 9/3234; G06F 21/86; G06F 21/88; H02J 7/0044

(57) ABSTRACT

Mobile-computer support apparatus comprises a stand, a dock on the stand for receiving a mobile-computing device such that at least a screen thereof is unobstructed from view, a charging element for charging the mobile-computing device when docked, and a locking mechanism for locking the mobile-computing device to the dock. The locking mechanism includes a retaining element locatable on a housing of the mobile-computing device, so as to be spaced from the screen, and a separate engagement element on or adjacent to the dock which releasably engages the retaining element so that, in use, the mobile-computing device is positively held to the dock.

This invention relates to a mobile-computer support apparatus, and more particularly but not necessarily essentially to tablet-computer support apparatus.

A stand for a computing device is known, and these are often seen in shops whereby a consumer can view and try the device before purchasing. To prevent or limit the chance of unauthorised removal or theft from the shop, the computing device is tethered to the stand via a security cable. This tethering allows the computing device to be freely positionable and movable on the stand, and removed to a certain specific distance before being restricted.

This known arrangement is unsuitable for situations where the mobile-computing device is being utilised as a sales aid or for informational purposes relating to another product. For example, in a car showroom, it is not acceptable to tether a mobile computing device to a stand in the vicinity of a showroom car, since this severely limits the convenience of the device to the salesperson. The salesperson would typically require the option of being able to sit in the vehicle with the prospective customer whilst using the device to display different interior colour schemes and layouts, for example.

When the mobile-computing device is not in use by the salesperson, having it securely locked in position without trailing security cables being visible is beneficial, thereby allowing a prospective consumer to utilise the computing device independently of the salesperson.

The present invention seeks to provide a solution to these problems.

According to a first aspect of the invention, there is provided mobile-computer support apparatus comprising a stand, a dock on the stand for receiving a mobile-computing device such that at least a screen thereof is unobstructed from view, a charging element for charging the mobile-computing device when docked, and a locking mechanism for locking the mobile-computing device to the dock, the locking mechanism including a retaining element locatable on a housing of the mobile-computing device so as to be spaced from the screen and a separate engagement element on or adjacent to the dock which releasably engages the retaining element so that, in use, the mobile-computing device is held to the dock.

Preferable and/or optional features of the first aspect of the invention are set forth in claims 2 to 25, inclusive.

According to a second aspect of the invention, there is provided mobile-computer support apparatus in accordance with the first aspect of the invention in combination with a mobile-computing device, wherein the locking mechanism includes an electronic release mechanism comprising a software user interface accessible via a display of the docked mobile-computing device, the software user interface being adapted for receiving a key for operating the electronic release mechanism.

Preferably, the docked mobile-computing device is rotatable relative to the dock via the rotatable mounting element.

According to a third aspect of the invention, there is provided mobile-computer support apparatus according to the first aspect of the invention in combination with a mobile-computing device, wherein, when the mobile-computing device is demounted from the stand, the mobile-computing device is untethered.

The invention will now be more particularly described, by way of example only, with reference to the accompanying drawings, wherein:

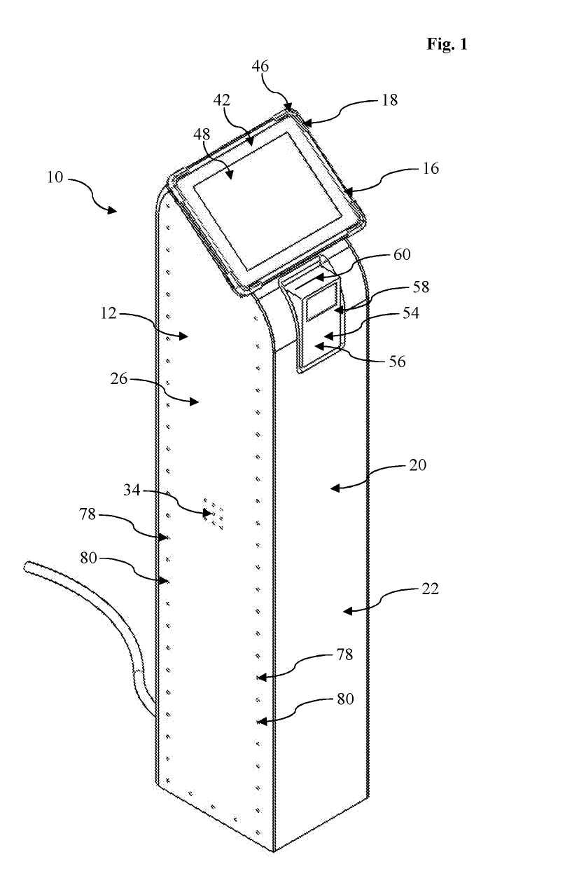

FIG. 1 is a perspective view of a first embodiment of mobile-computer support apparatus, in accordance with the invention and showing a dockable mobile-computing device docked thereon;

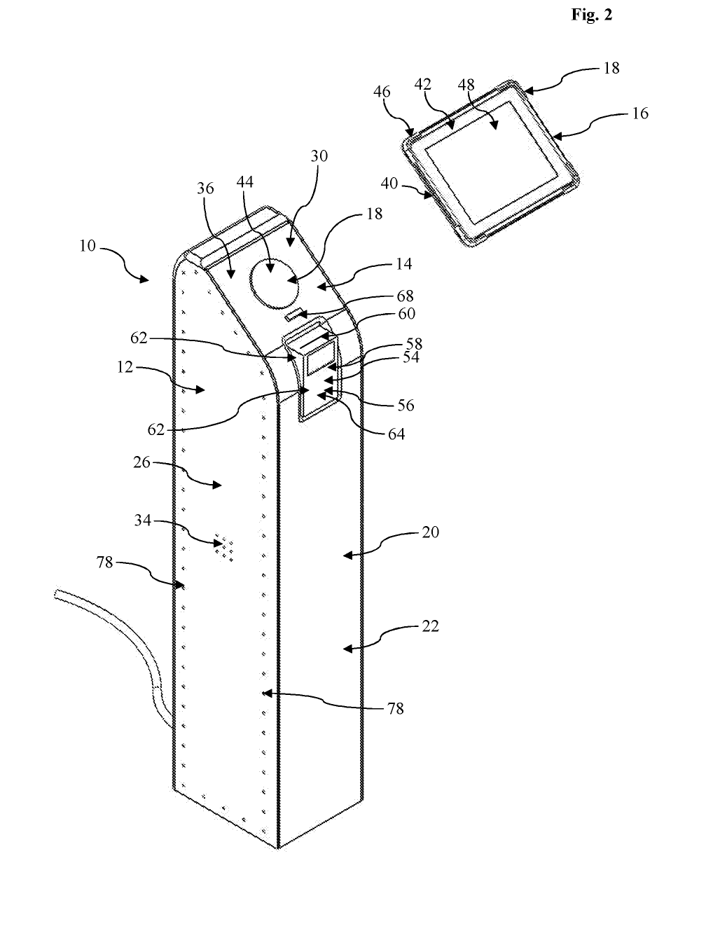

FIG. 2 is a perspective view similar to FIG. 1 and showing a dockable mobile-computing device spaced apart from the apparatus for clarity;

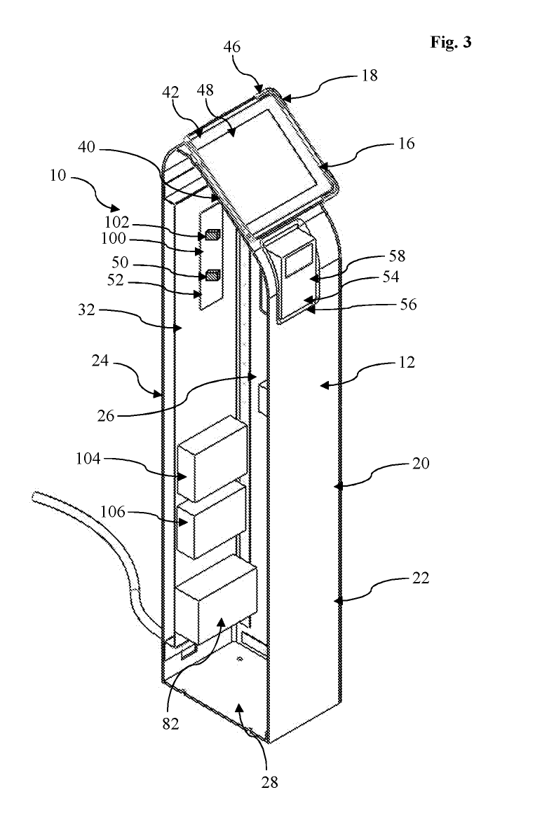

FIG. 3 is a vertical cross-sectional view of the mobile-computer support apparatus, shown in FIG. 1;

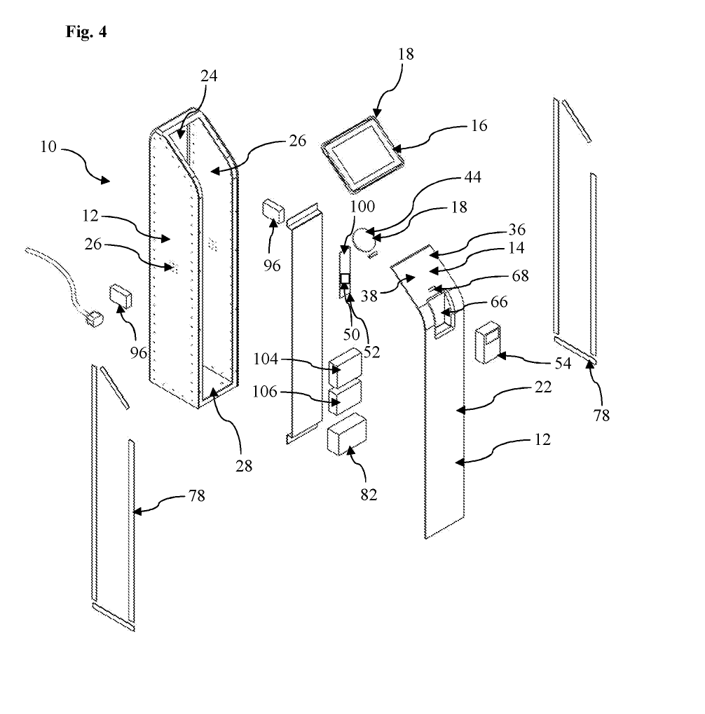

FIG. 4 is an exploded view of the mobile-computer support apparatus;

FIG. 5 is a block diagram of the mobile-computer support apparatus;

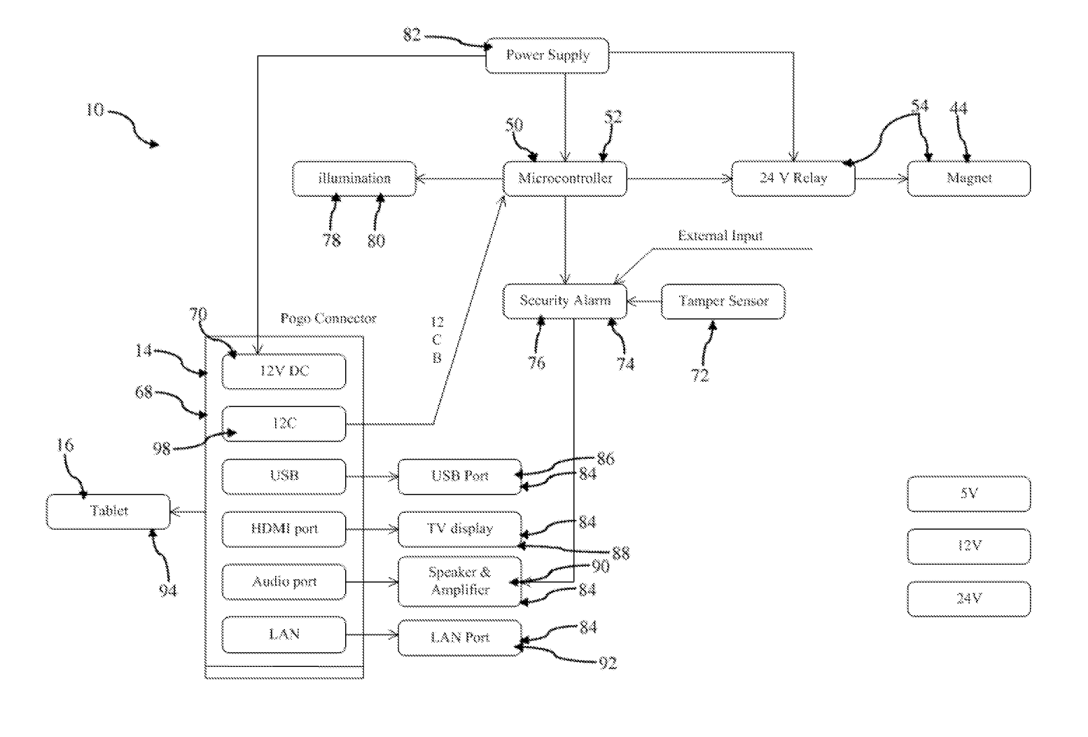

FIG. 6 is a front perspective view of a second embodiment of the mobile-computer support apparatus, in accordance with the present invention;

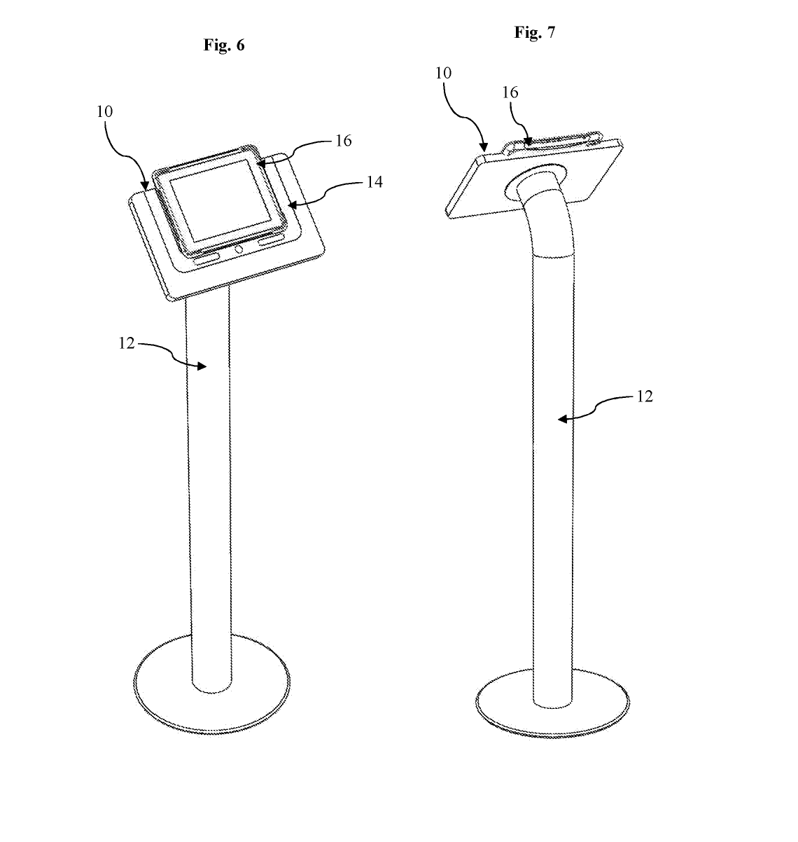

FIG. 7 is a rear perspective view of the mobile-computer support apparatus as shown in FIG. 5;

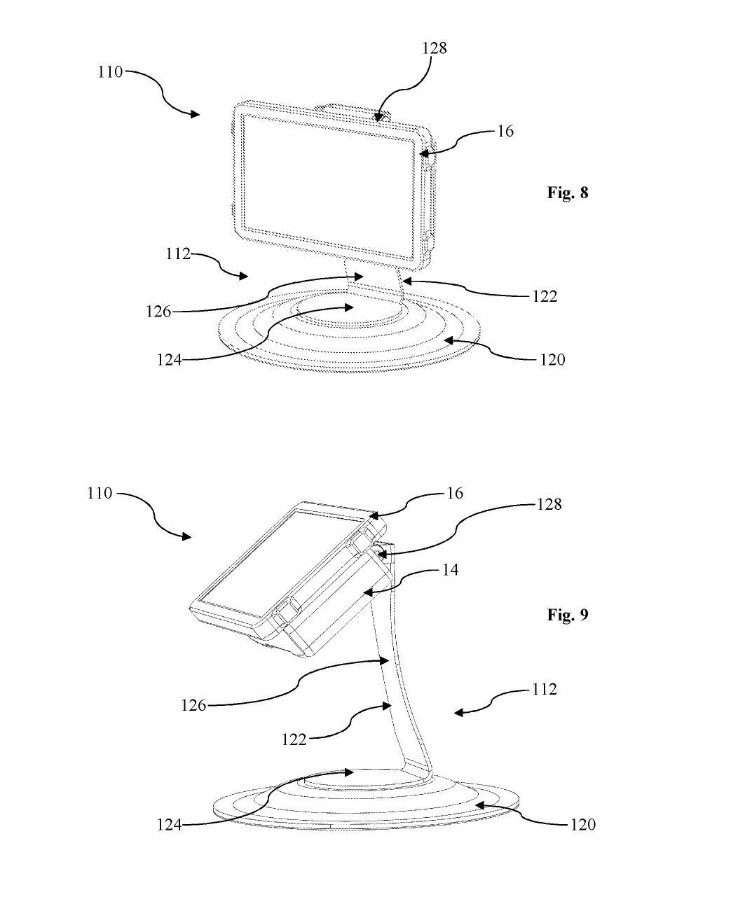

FIG. 8 is a front perspective view of a third embodiment of mobile-computer support apparatus, in accordance with the present invention;

FIG. 9 is a side perspective view of the mobile-computer support apparatus, as shown in FIG. 8;

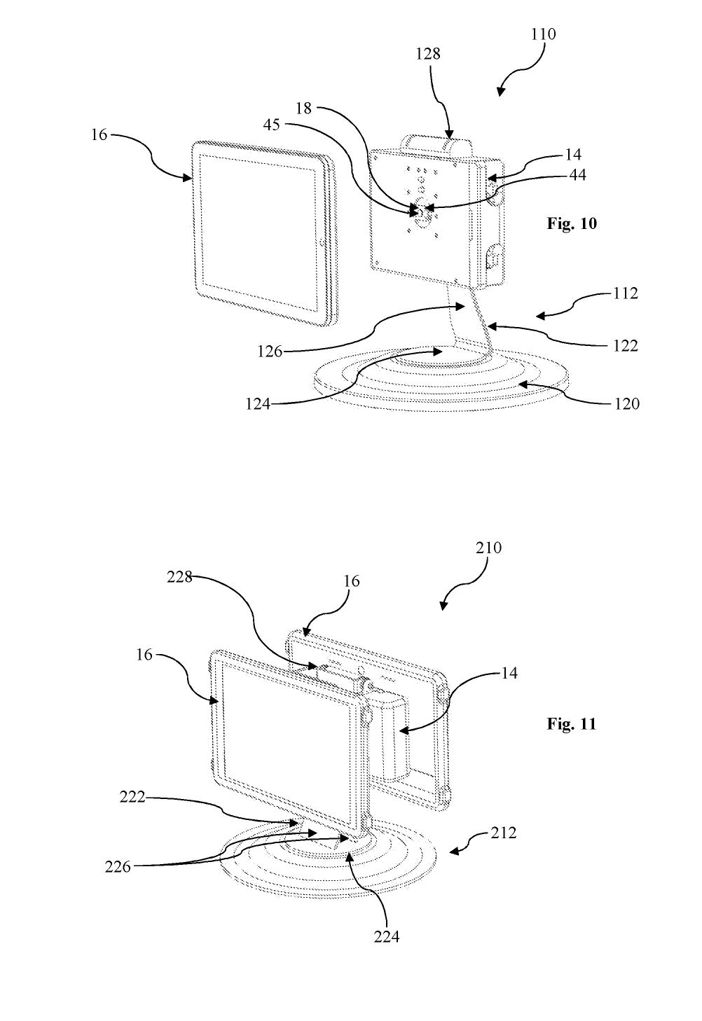

FIG. 10 is a partially exploded view of the mobile-computer support apparatus, as shown in FIG. 8; and

FIG. 11 is a front perspective view of a fourth embodiment of mobile-computer support apparatus, in accordance with the present invention.

Referring firstly to FIGS. 1 to 5 of the drawings, there is shown a first embodiment of mobile-computer support apparatus 10, which comprises a stand 12, a dock 14 on the stand 12 for a mobile-computing device 16, and a locking mechanism 18 for locking the mobile-computing device 16 to the dock 14 in an untethered manner.

The stand 12 in this embodiment is an upright and elongate pedestal-type floor-mountable cabinet 20 comprising a front wall 22, a rear wall 24, two opposing side walls 26 which extend contiguously between the front and rear walls 22, 24, a base 28 and a top 30. The walls 22, 24, 26 are preferably uniformly continuous or substantially continuous along at least a majority of their longitudinal and lateral extents, and the walls 22, 24, 26 together with the base 28 and the top 30 define an interior chamber 32, reasons for which will become apparent hereinafter.

The walls 22, 24, 26 of the stand 12 are preferably planar or substantially planar again over at least a majority of their longitudinal and lateral extents, and advantageously the side walls 26, front wall 22 and/or the rear wall 24 may include one or more small and discreet speaker apertures 34 for sound output.

An upper exterior surface 36 of the top 30 is slanted so as to ramp upwardly away from the front wall 22 and towards the rear wall 24, and the dock 14 is defined by the slanted top surface 36. Again, at least a majority of the top surface 36 is preferably planar to provide a suitable docking surface 38 for the mobile-computing device 16.

The locking mechanism 18, in this embodiment and by way of example, is preferably an electromagnetic locking mechanism and comprises a retaining element 40 which is locatable on or adjacent to a housing 42 of the mobile-computing device 16 and a separate engagement element 44 which is provided on the dock 14 for releasably magnetically-engaging the retaining element 40.

Beneficially, the mobile-computing device 16 includes an independent secondary housing 46 in which the original housing 42 of the mobile-computing device 16 is seatable. The secondary housing 46 locates over a perimeter edge of the original housing 42 so as not to obscure a display 48 of the mobile-computing device 16. The secondary housing 46 may have uniformly continuous walls and surfaces, or may be apertured, for example, in the form of a web.

The retaining element 40 is integrally formed as part of the secondary housing 46 or as part of the original housing of the device 16, and is preferably one or more ferrous plates or elements which can be magnetically engaged with the engagement element 44.

Although preferably a ferrous element, the retaining element 40 itself may be electromagnetic, being controllable by the stand 12 once the mobile-computing device 16 is docked.

The engagement element 44 is preferably one or more electro-magnetic plates on or adjacent to the dock 14. In this case, the electro-magnetic plate is mounted in an aperture in the top surface 36 and is controlled via a control circuit 50 of a controller 52 within the stand 12.

Although circular, the engagement element 44 may be any suitable shape, and is preferably smaller in dimension than the mobile-computing device 16 so as not to overlap the perimeter edges of the device when docked.

In an alternative arrangement, the engagement element may be provided on a lower surface of the top 30, or even in slightly spaced relationship with the lower surface of the top 30. This would provide a cleaner or less cluttered aesthetic appearance with the mobile-computing device 16 undocked.

The locking mechanism 18 includes an electronic release mechanism 54, which in this case comprises a user interface 56 on an exterior of the stand 12. The user interface 56 is adapted to receive a key, and for example may be formed as part of a smartcard reader 58 or which may be an iButton RTM. In the former case, the smartcard reader 58 preferably includes a receiver 60, for example, a slot in a reader housing 62, for receiving the smartcard, and a keyboard 64 or other data entry device for inputting a unique and/or personal numeric or alphanumeric string associated with data held by a microchip embedded into the smartcard.

It is convenient to provide the smartcard reader 58 in the vicinity of the dock 14, and in this embodiment, the smartcard reader 58 is provided in a recess 66 formed into an upper front edge of the stand 12, between the front wall 22 and the top 30.

It may also be convenient to provide the smartcard reader 58 as a removable dockable device in its own right, so that a user can more discreetly enter their confidential information in order to operate the electronic release mechanism 54. To this end, the smartcard reader 58 may even be wireless, rather than being tethered, and as such would include a suitable transmitter with appropriate receiver within the stand 12 and utilise a suitably secure wireless data transfer protocol.

Although a smartcard and counterpart reader are suggested as being the key and user interface for operating the electronic release mechanism, any suitable user interface can be utilised. For example, a software user interface accessible via the display 48 of the docked mobile-computing device could be additionally or alternatively utilised. The software user interface would be adapted for receiving a user-inputted key via a, preferably touch or pressure sensitive, display of the mobile-computing device 16.

The electronic release mechanism 54 could also be operable by a more traditional mechanical key. This could be an override option, for example. The mechanical key would be insertable into a lock on the stand 12, which in turn operates the electronic release mechanism 54 thereby allowing the docked mobile-computing device 16 to be undocked.

In the case of the aforementioned iButton RTM key, the key is provided as a resilient metal housing with a microchip stored therein. The metal housing provides a data contact, called the lid, and a ground contact, called the base. Each of these contacts is connected to the chip inside. The lid is the top of the can; the base forms the sides and the bottom of the can and includes a flange to simplify attaching the button to just about any item or device, such as a keyfob. The two contacts are separated by a polypropylene grommet. By touching the iButton RTM housing to two contacts communication through the 1-Wire RTM protocol is possible. In this way, the electronic release mechanism 54 can be operated, allowing a specific user associated with the respective iButton RTM to release the device 16.

A data-transfer connector 68 is also provided on the dock 14, allowing the mobile-computing device 16 to communicate with the stand 12 when docked. Conveniently, the data-transfer connector 68 may be a POGO connector, but any other suitable connector may be utilised. Furthermore, although the data-transfer connector 68 is a hardware device, it may additionally or alternatively be realised as a software device, whereby data-transfer is achievable wirelessly between the docked mobile-computing device 16 and the stand 12.

Preferably provided in addition to the data-transfer connector 68, is a charging element 70. Again, the charging element 70 may be a physical or mechanical connection or may be wireless by the use of an inductive charging system. In either case, the charging element 70 is provided on the stand 12 and is adapted to interface with the docked mobile-computing device 16 so that, whilst docked, an on-board battery of the mobile-computing device 16 is charged.

Preferably, the apparatus 10 further includes a tamper sensor 72 for sensing an unauthorised attempt to remove the docked mobile-computing device 16. The tamper sensor 72 may for example be a pressure sensor incorporating a load cell or strain gauge for monitoring a certain force imparted to the mobile-computing device 16 and/or the stand 12.

It is convenient to provide the tamper sensor 72 on or as part of the engagement element 44 of the locking mechanism 18.

In addition to the tamper sensor 72, the apparatus 10 is also preferably provided with an alarm 74 which is energisable via an alarm circuit 76 by an output of the tamper sensor 72. The alarm 74, in this embodiment, includes a visual output device 78 comprising a plurality of strips of light emitting elements 80 along at least two opposing edges of the stand 12. The light emitting elements 80 are a convenient addition to the stand 12, in any event, in order to attract a consumer's attention. However, in addition to an audible alarm output, a visual alarm output formed by flashing and/or differently coloured light emitting elements 80 may be beneficial.

Stand controller 52 is provided within the interior chamber 32 of the stand 12, along with a power supply unit 82. The stand controller 52 controls the light emitting elements 80 for the stand illumination, along with the alarm circuit 76 and associated tamper sensor 72. The electronic release mechanism 54 is also controlled by the stand controller 52, along with data transfer to and from the docked mobile-computing device 16. The stand controller 52 also regulates the charging element 70, so that an over-charging state of a docked mobile-computing device 16 is not reached.

Additionally, various input and output ports 84 may be provided on the stand 12, and these would all be controlled via the stand controller 52. By way of example, one or more USB ports 86, HDMI ports 88, audio ports 90 and LAN ports 92 may be included. The mobile-computing device 16 may also include one or more corresponding ports 94, and suitable data transfer can take place between the mobile-computing device 16 and the stand 12 via the data-transfer connector 68. This would thus allow, for example, a video to be played by the docked mobile-computing device 16 and outputted to the stand 12, which in turn could output through its respective ports 84 to a large peripheral display and amplifier-driven speakers. Alternatively, whilst the video is being displayed by the display 48 of the docked mobile-computing device 16, higher quality audio can be outputted by amplifier-driven speakers 96 located within the interior chamber 32.

The stand controller 52 may advantageously utilise a multi-master serial single-ended computer bus 98 within the stand 12 to provide data communication between the charging element 70, various ports 84 mentioned above, tamper sensor 72, alarm circuit 76, locking mechanism 18 and a power distribution board 100. The multi-master serial single-ended computer bus 98 in this case preferably utilises a System Management Bus, which is derived from I²C beneficially allowing low bandwidth data communication between main circuits and subsystems.

By use of such a System Management Bus, a charge determination circuit 102 of the charging element 70 can monitor a charge level of a battery of the docked mobile-computing device 16, as discussed above. Other monitoring options are also available via the System Management Bus, for example, indicating when a battery of the computing device 16 may need to be replaced, and if an internal temperature is too high.

The apparatus 10 is also able to provide wireless internet and/or server access. To this end, the apparatus 10 may include a wireless access point or WAP device 104 within the interior chamber 32. The WAP device 104 is powered by the power supply unit 82, preferably being fed through the power distribution board 100 associated with the stand controller 52.

In this case, the stand 12 preferably has a network cable socket, such as the LAN port 92 mentioned above, for connection of an Ethernet cable to a hard wired internet connection of the installation site. Alternatively, the WAP device 104 may act as a wireless router or switch wirelessly connecting the stand 12 and the associated mobile-computing device 16 to a further wireless router or modem of the installation site.

Additionally or alternatively, a server computer device 106 may be included locally, preferably in the interior chamber 32. This allows the stand 12 to directly serve the client-based mobile-computing device 16 when docked and undocked. For example, specific software or files may be preloaded onto the server computer device 106 for direct wireless access by the mobile-computing device. In this case, pre-configuration of an existing remote server device at the installation site may not be required and as such, for example, limited internet access may be established. This would be beneficial in an educational, medical or retail establishment, for example, where it may be necessary to only allow specific local and approved content to be available whilst restricting or preventing Internet content.

To enable a complete standalone computational ecosystem to be provided, in addition to the WAP device 104 and server computer device 106, it would be beneficial to provide an uninterruptable power supply or UPS battery backup within the stand 12.

Additionally, it may be beneficial to enable interconnection for data transfer between like apparatuses 10. In this case, daisy-chaining can be achieved typically via a physical cable, such as an Ethernet cable. A first stand 12 can thus operate as a hub in terms of server operation, whereby data received by and requested from a second like-stand is transferred to the server computer device 106 of the first stand 12 for processing. A third similar stand may be daisy-chained to the second stand 12 for data transfer therethrough to the first stand 12.

It is envisaged that this data daisy-chaining may occur if like stands 12 are modularly mechanically interconnectable, forming a bank of stands 12. However, the apparatus 10 acting as the server hub may do so wirelessly, and as such further said apparatuses 10 may be interconnected wirelessly for server access, instead of or in addition to being hard-wired together.

FIGS. 6 and 7 show a second embodiment of mobile-computer support apparatus 10. Similar references refer to the same or similar parts, and further detailed description is therefore omitted.

This apparatus 10 is similar to that of the first embodiment, with the only substantial difference being the shape and configuration of the stand 12. The stand 12 of the second embodiment is elongate and slender, providing a substantially cylindrical upstanding pedestal portion and a cantilevered arm portion which supports the dock 14 for the mobile-computing device 16. The locking mechanism 18 for locking the mobile-computing device 16 to the dock 14 in an untethered manner is as described above.

FIGS. 8 to 10 show a third embodiment of mobile-computer support apparatus 110. Similar references refer to the same or similar parts, and further detailed description is therefore omitted.

This apparatus 110 is similar to the first and second embodiments, a main difference being a further change to the shape and configuration of stand 112. The stand 112 of the third embodiment has a reduced vertical extent relative to the stand 12 as described in the first and second embodiments, and is primarily designed for mounting on a tabletop rather than at ground level. However, a modified stand for floor mounting could be formed utilising the features and functionality of the stand 112.

Similarly, it is feasible that a stand for raised mounting, incorporating one or more of the features and functionality of the first and/or second embodiments, could be formed.

Equally, a composite stand utilising one or more features alone or in combination of all of the proposed embodiments could be formed.

The stand 112 provides a slightly domed, raised or stepped pedestal base 120 and a cantilevered support arm 122 which supports the dock 14 for the mobile-computing device 16. The locking mechanism 18 for locking the mobile-computing device 16 to the dock 14 in an untethered manner is preferably as described above.

The support arm 122 is preferably rotatably mounted to the base 120, and beneficially this may be at or substantially at the centre of the base 120.

The base 120 may be weighted, and in any event is preferably fastenable to a mounting surface. Conveniently, a fastening device and/or fastening plate may be accessed through an access opening which is revealed when disengaging the support arm 120 from the base 122. Other alternative or additional options for connecting the base 120 to the support surface may include adhesive.

As an alternative, a foot 124 of the support arm 122, which extends transversely to an upstanding body 126 of the support arm 120, may include a fastening mechanism which enables fastening of the arm 122 and the base 120 together to a support surface. For example, this may be a screw-threaded fastener and receptive port which extends, preferably centrally, through the foot 124 and base 120.

In this embodiment, the dock 14 is pivotably engaged with a distal end portion of the arm 122. The pivotable engagement is preferably hinged about at least a horizontal axis, being perpendicular to a rotational axis of the arm 122 at the base 120.

This pivotable engagement of the dock 14, shown in FIG. 9, is particularly beneficial in enabling the mobile-computing device 16 and more particularly the independent secondary housing 46 to impart a user selectable tilt or pitch to a screen of the supported mobile-computing device 16, whilst also allowing simultaneous selectable rotation.

The hinge 128 between the dock 14 and the arm 122 is preferably of sufficiently high friction to retain the mobile-computing device 16 at a given tilt or pitch. Additionally or alternatively, the hinge may include an indexing mechanism to enable positive engagement at a plurality of angularly different tilted positions.

Referring to FIG. 11, a fourth embodiment of the mobile-computer support apparatus 210 is shown. Although the apparatus 210 is substantially the same as the third embodiment, the stand 222 provides back to back support arms 222, preferably having a common foot 224 and cantilevered upstanding bodies 226. The bodies 226, as with the third embodiment, are preferably plate-like, having a slightly arcuate, kinked, cranked or doglegged longitudinal extent. However, other forms can be envisaged, such as tubular, cylindrical, swan neck, and/or hollow.

The foot 224 is preferably similar to that of the third embodiment, and thus may be generally in the form of a circular or part-circular plate. As in the third embodiment described above, the foot 222 is mounted for rotatable movement about an in use vertical axis to the base 220.

As with the third embodiment, a dock 14 is pivotably engaged via respective hinges 228 with a distal end portion of each support arm 222, thereby allowing horizontal tilt or pitch adjustment of the docked mobile-computing device 16.

Should the body not be plate-like, for example, if it has a circular or polygonal lateral cross-section, then the foot may be dispensed with since the body may terminate directly at the base. However, in this case, the engagement of the body with the base still enables rotatable movement.

Although in use horizontal tilt or pitch adjustment, along with in use vertical rotational adjustment, is provided by the third and fourth embodiments, it is additionally or alternatively preferable that yaw adjustment and/or pivotable adjustment, preferably being 360 degree rotation, about an axis which is perpendicular to a pivot axis of the hinge may also be incorporated. Such adjustments may also be provided for the first and second embodiments. In the case of rotational adjustment, allowing the mobile computing device 16 to be turned relative to the dock 14 through preferably 360 degrees, a rotatable mounting element 45 is included, preferably as part of the dock 14 and as shown in FIG. 10. In this case, it may be advantageous to combine the rotatable mounting element 45 with the separate engagement element 44, thereby allowing the separate engagement element 44, typically being an electro-magnetic retainer, to rotate in or on the dock 14 whilst also enabling the charging element 70 to interface with the docked mobile computing device 16 for charging.

The mobile-computing device referred to herein throughout is preferably a tablet computing device with a touch or pressure sensitive display screen. The retaining element of the locking mechanism is locatable on the original housing of the mobile-computing device so as to be spaced from and not occlude in any way the screen.

It is therefore possible to provide mobile-computer support apparatus which allows a mobile-computing device, and most preferably a tablet computer, to be docked thereon without obstruction of the screen. The mobile-computing device can thus be used as a pedestal mounted display, as required. The mobile-computing device is securely and releasably locked to the stand at its docking point and without a security cable, thereby providing an integrated visual appearance. However, on release, the mobile-computing device can be disengaged from the stand and, without being tethered, can be freely used by an authorised person.

1. Mobile-computer support apparatus comprising a stand, a dock on the stand for receiving a mobile-computing device such that at least a screen thereof is unobstructed from view, a charging element for charging the mobile-computing device when docked, and a locking mechanism for locking the mobile-computing device to the dock the locking mechanism including a retaining element on a housing of the mobile-computing device so as to be spaced from the screen and a separate engagement element on or adjacent to the dock which releasably engages the retaining element so that, in use, the mobile-computing device is held to the dock.

2. Mobile-computer support apparatus as claimed in claim 1, wherein the locking mechanism is magnetic, the retaining element being magnetically engagable with the engagement element.

3. Mobile-computer support apparatus as claimed in claim 2, wherein the engagement element is an electro-magnetic plate on or adjacent to the dock.

4. Mobile-computer support apparatus as claimed in claim 2, wherein the retaining element is an at least in part ferrous casing in which the mobile-computing device is locatable.

5. Mobile-computer support apparatus as claimed in claim 1, wherein the locking mechanism includes an electronic release mechanism.

6. Mobile-computer support apparatus as claimed in claim 5, wherein the electronic release mechanism comprises a user interface for receiving a key for operating the electronic release mechanism.

7. Mobile-computer support apparatus as claimed in claim 6, wherein the key includes a smartcard, and the user interface includes a receiver and reader for receiving and reading the smartcard.

8. Mobile-computer support apparatus as claimed in claim 7, wherein the key further includes a personal identification code, and the user interface includes a data-entry device for entering the personal identification number.

9. Mobile-computer support apparatus as claimed in claim 6, wherein the user interface is provided on the stand.

10. Mobile-computer support apparatus as claimed in claim 1, further comprising a tamper sensor for sensing an unauthorised attempt to remove a mobile-computing device mounted to the dock.

11. Mobile-computer support apparatus as claimed in claim 10, wherein the tamper sensor is a pressure sensor.

12. Mobile-computer support apparatus as claimed in claim 10 or claim 11, wherein the tamper sensor is provided on the locking mechanism.

13. Mobile-computer support apparatus as claimed in claim 10, further comprising an alarm energisable by an output of the tamper sensor.

14. Mobile-computer support apparatus as claimed in claim 13, wherein the alarm includes a visual output device comprising a plurality of strips of light emitting elements along at least two opposing edges of the stand.

15. Mobile-computer support apparatus as claimed in claim 1 wherein the stand is an elongate upstanding floor-mountable housing.

16. Mobile-computer support apparatus as claimed in claim 1, wherein the stand is table-top mountable.

17. Mobile-computer support apparatus as claimed in claim 16, wherein a support arm of the stand is able to rotate about a base.

18. Mobile-computer support apparatus as claimed in claim 17, wherein the dock is pivotably engaged with the support arm.

19. Mobile-computer support apparatus as claimed in claim 17, further comprising a rotatable mounting element associated with the dock by which a docked mobile-computing device is rotatable relative to the dock.

20. Mobile-computer support apparatus as claimed in claim 19, wherein the rotatable mounting element forms part of the locking mechanism.

21. Mobile-computer support apparatus as claimed in claim 20, wherein the rotatable mounting element includes the separate engagement element.

22. Mobile-computer support apparatus as claimed in claim 17, wherein two said support arms are rotatably mounted to the base.

23. Mobile-computer support apparatus as claimed in claim 1, further comprising a wireless access point device within the stand.

24. Mobile-computer support apparatus as claimed in claim 23, further comprising a server element and battery backup device within the housing, the wireless access point device being in communication with the server element.

25. Mobile-computer support apparatus as claimed in claim 1, further comprising a data-transfer connector on the dock for enabling data transfer from a docked mobile-computing device to the stand.

26. Mobile-computer support apparatus as claimed in claim 1 in combination with a mobile-computing device, wherein the locking mechanism includes an electronic release mechanism comprising a software user interface accessible via a display of the docked mobile-computing device, the software user interface being adapted for receiving a key for operating the electronic release mechanism.

27. A combination as claimed in claim 26, wherein the docked mobile-computing device is rotatable relative to the dock via the rotatable mounting element.

28. Mobile-computer support apparatus as claimed in claim 1 in combination with a mobile-computing device, wherein, when the mobile-computing device is demounted from the stand, the mobile-computing device is untethered.
